(19) United States
(12) Patent Application Publication
(10) Pub. No.: US 2010/0290876 A1
(43) Pub. Date: Nov. 18, 2010

(54) Cargo Lift For All Terrain Vehicle

(76) Inventor: Tracy Conatser, Ripley, TN (US)

Correspondence Address: Kenneth E. Barnes, 80 Monroe Ave. Suite G-1, MEMPHIS, TN, 38103, US

(21) Appl. No.: 12/782,624

(22) Filed: May 18, 2010

Related U.S. Application Data
(60) Provisional application No. 61/179,181, filed on May 18, 2009.

(51) Int. Cl. B60P 1/44

(52) U.S. Cl. 414/471

(57) ABSTRACT

A cargo lift operable by a single operator that may be used to lift and transport a variety of cargo, and which may be mounted to many types of all terrain-vehicles. The lift may be folded when not in use. Other embodiments are disclosed.

### BACKGROUND OF THE INVENTION

All-terrain vehicles (ATVs) are a popular means of off-road transportation for hunters, farmers, ranchers and rural residents, and are used to transport people and equipment to areas far from available roads. These vehicles are small and maneuverable, but their carrying capacity is limited by their small size. Existing cargo racks for ATVs are typically mounted atop the front or rear fenders and provide some space for tools, packs and other small, relatively lightweight items. The size and location of such cargo racks, and the high ground clearance of the ATV, makes it difficult to load and carry larger, heavier items due to the need to lift the cargo up onto the vehicle, and the limited space available. Trailers for ATVs are known in the art, but attaching a trailer sacrifices some of the maneuverability of the vehicle, and trailers take up additional space when parking, even if not in use. Trailers are also only suitable for attachment to the rear of the vehicle. A need therefore exists in the art for a cargo carrier for ATVs that facilitates transporting larger, heavier items, that can be attached to either the front or rear of the vehicle, and that takes up a minimum of space when not in use.

### BRIEF DESCRIPTION OF THE DRAWINGS

FIG. 1 is a perspective view showing the bottom and back of a lift apparatus with the lift platform in a lowered position, according to an embodiment of the invention.

FIG. 2 is a perspective view corresponding to FIG. 1, showing the front of the lift apparatus with the lift platform in a lowered position, according to an embodiment of the invention.

FIG. 3 is a perspective view showing the front of the lift apparatus with the lift platform in a raised position, according to an embodiment of the invention.

FIG. 4 is a perspective view showing the right side of the lift apparatus with the lift platform in a raised position, illustrating an alternative attachment means and the pivoting of the lift platform into a stowed position, according to an embodiment of the invention.

FIG. 5 is a perspective view showing the front of the lift apparatus with the lift platform in a raised and stowed position, and illustrating a removable pin in position for latching the lift platform in a stowed position, according to an embodiment of the invention.

FIG. 6 is a perspective view showing the back of the lift apparatus with the lift platform in a raised and stowed position, and illustrating an adjustable receiver mount, according to an embodiment of the invention.

### REFERENCE NUMBERS

100 Winch
102 Winch handle
104 Winch bolt
106 Winch bolt nut
110 Mounting frame
112 Upper cable passthrough
114 Adjustable attachment means
116 Adjusting bar
118 Adjustment holes
120 U-bolt
122 Mounting bracket
124 Mounting bracket—bolt
126 Mounting bracket—clamp bolt
128 Nut
130 Spacer
140 Adjustable brace
142 Adjustable brace—outer member
144 Adjustable brace—inner member
146 Alignment holes
148 Alignment bolt
150 Alignment bolt nut
152 Hitch mount foot
154 Hitch mount foot bolt
156 Hitch mount foot nut
160 Lifting frame
162 Lower cable passthrough
164 Cable connection point
166 Lift platform attachment member
168 Hold down pin hole
170 Cable
172 Cable connector
180 Lift platform support arm
182 Pivot bolt
184 Removable pin
186 Retaining clip
190 Lift platform
192 Rail
194 Decking
196 Tiedown
200 Receiver mount
202 Receiver adjustment holes
204 Receiver mount bolts
206 Horizontal brace
210 Vertical brace
212 Upper vertical brace bolt
214 Lower vertical brace bolt

### DETAILED DESCRIPTION OF THE DRAWINGS

The preferred embodiments of the invention are now described with reference to the accompanying drawings.

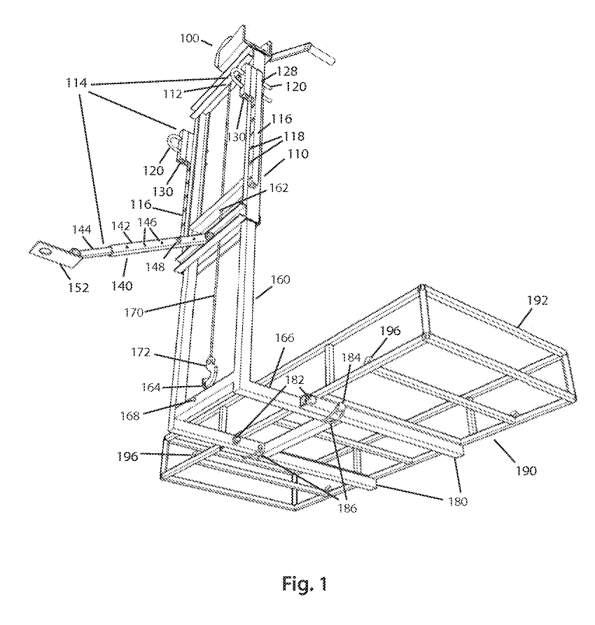

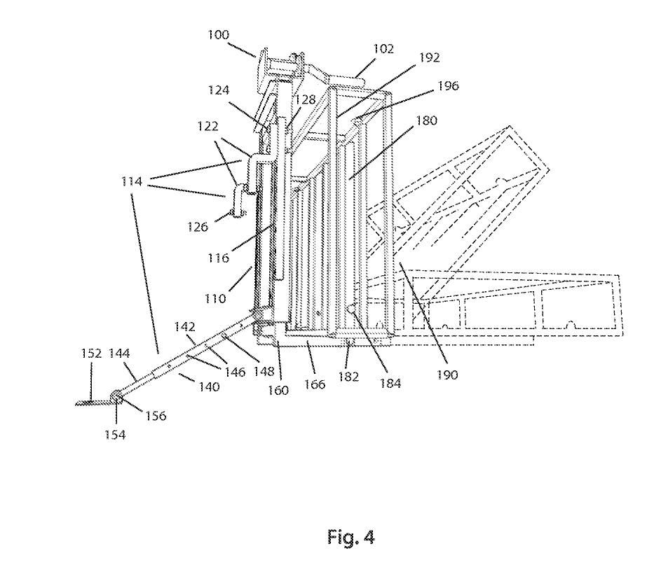

FIG. 1 is a perspective view showing the bottom and back of a lift apparatus according to an embodiment of the invention. A mounting frame 110 is attached to a motorized vehicle, such as an all-terrain vehicle, via adjustable attachment means 114, which in a preferred embodiment include U-bolts 120 positioned in adjusting bars 116 attached to the sides of the mounting frame 110, and an adjustable brace 140 attached to the bottom of the mounting frame 110, the adjustable brace 140 having a hitch mount foot 152. The adjusting bars 116 may provide a series of adjustment holes 118 for positioning the U-bolts 120, which may be used to attach the mounting frame to the cargo rack of the motorized vehicle. Spacers 130 may be used if necessary to adapt the apparatus to different motorized vehicles and to adjust the mounting frame 110 to a desired vertical position. Alternative attachment means may also be used, such as shown in FIG. 4. The hitch mount foot 152 may be configured to be mounted to a hitch on the motorized vehicle, such as beneath the hitch ball of a ball-type hitch, and the adjustable brace 140 may be articulated and configured to telescope along its length, to permit adjustment of the mounting frame to a desired vertical position. In a preferred embodiment, the adjustable brace has an outer member 142 and an inner member 144, both of which have a corresponding series of alignment holes 146. The inner member is configured to slide within the outer member to a predetermined length, where the alignment holes 146 are aligned, and the inner member and the outer member are joined together by an alignment bolt 148 passing through both members. The alignment bolt 148 is secured by a nut 150.

A winch 100 is attached to the mounting frame, and in a preferred embodiment, the winch is a manual winch attached to the top of the mounting frame 110 with bolts 104, that are secured by nuts 106. Alternative lifting means, such as an electric winch or other powered winch may be used.

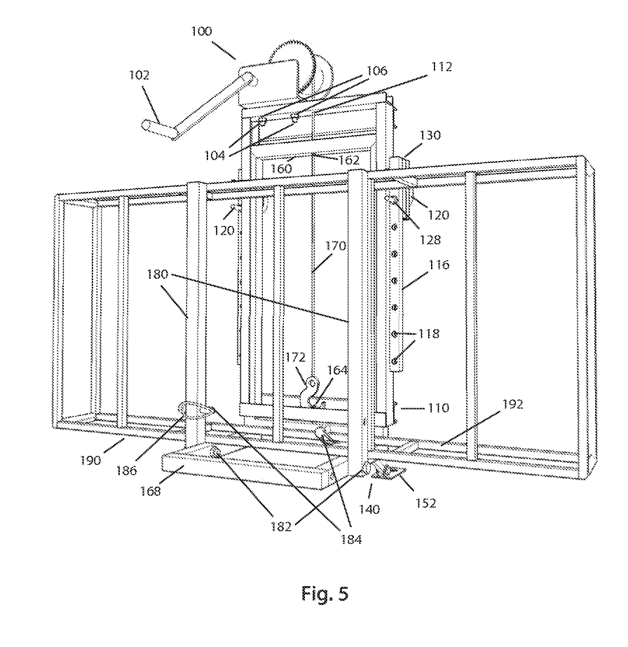

A lifting frame 160 is configured to slide within the mounting frame 110. A cable 170 attached to the winch 100 feeds through an upper cable passthrough 112 hole centered in the top of the mounting frame 110 (better shown in FIG. 5) and through a similar lower cable passthrough 162 hole centered in the top of the lifting frame 160, where it is attached to a cable connection point 164 on the lifting frame 160 by a cable connector 172, such as a hook or carabiner. A lift platform attachment member 166 extends perpendicularly from the lifting frame 160.

A lift platform 190 is attached to the lift platform attachment member 166 and configured to pivot between a horizontal and vertical position, as shown in FIG. 4. The lift platform 190 is here depicted in a horizontal lowered position. Lift platform support arms 180 are attached to the bottom of the lift platform 190, and extend towards the lifting frame 160, where they are attached to the lift platform attachment member 166. In a preferred embodiment, the lift platform support arms 180 are attached to the lift platform attachment member 166 by pivot bolts 182. Alternative pivoting mechanisms, such as hinges, may be used.

In a preferred embodiment, removable pins 184 extending through holes in the lift platform support arms 180 and lift platform attachment member 166 are configured to latch the lift platform 190 in the horizontal position, and may include retaining clips 186 to hold the pins in place. Demounting of the removable pins 184 permits the lift platform 190 to be pivoted into a vertical position for stowing, as shown in FIG. 4. In a preferred embodiment, one of the removable pins 184 may be used to latch the lift platform in a vertical position by inserting it into a hold down pin hole 168 in the lifting frame 160, as shown in FIG. 5.

The mounting frame 110, adjusting bars 116, adjustable brace 140, lifting frame 160, lift platform attachment member 166, lift platform 190, and lift platform support arms 180 can be fabricated from any suitable rigid material, such as metals or composite materials. In a preferred embodiment, the lifting frame 160, lift platform attachment member 166, lift platform 190, and lift platform support arms 180 are made from square steel tubing; the adjustable brace 140 is made from square steel tubing, with the hitch mount foot 152 fabricated from steel plate; and the mounting frame 110 is made from square steel “C”-channel, with adjusting bars 116 and spacers 130 made from square steel tubing. Although square tubing is preferred for ease of fabrication, tubing having other cross sections, or even solid rod or bar stock could be substituted. The winch 100, U-bolts 120, removable pins 184, bolts, eye bolt, cable 170, and other hardware are standard, and in a preferred embodiment are made of metal. In a preferred embodiment, except where bolts or other fasteners are needed for articulation or adjustment, the mounting frame 110, adjusting bars 116, lifting frame 160, lift platform attachment member 166, lift platform 190, and lift platform support arms 180 may be fabricated and joined by welding.

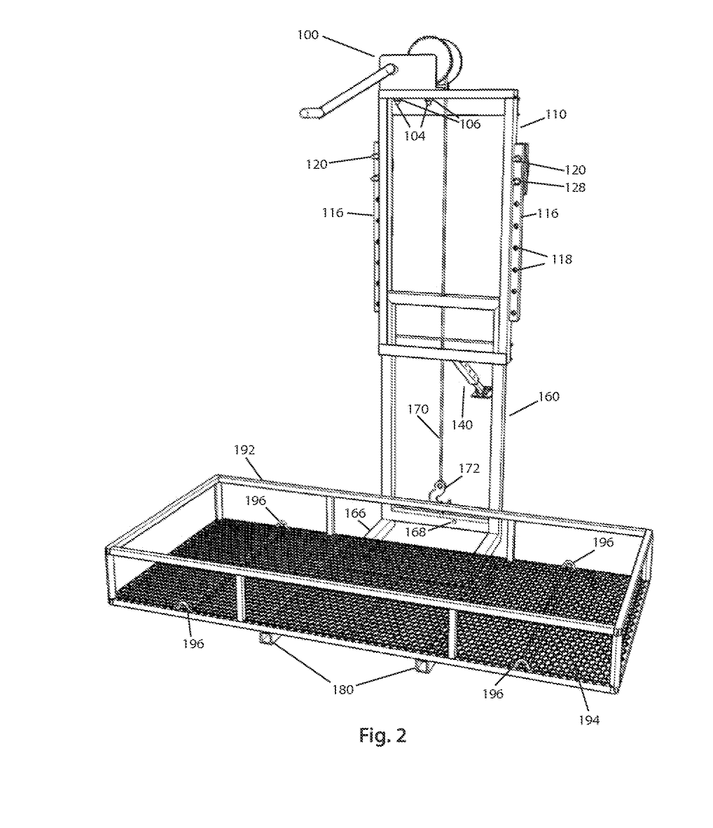

FIG. 2 is a perspective view similar to FIG. 1, showing the front of the lift apparatus with the lift platform 190 in a lowered position, according to an embodiment of the invention. In a preferred embodiment, the lift platform 190 may include tiedowns 196 for use in securing a load, a rail 192 to prevent a load from sliding off the lift platform, and decking 194, such as expanded metal, to provide additional support to the load.

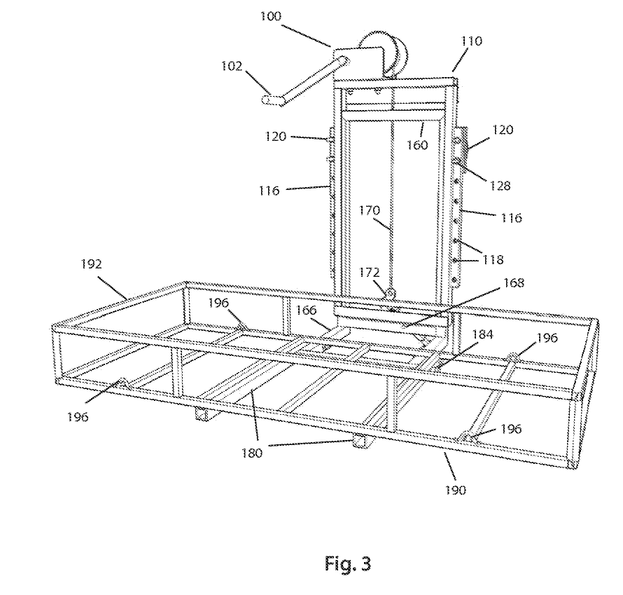

FIG. 3 is a perspective view showing the front of the lift apparatus with the lift platform 190 in a raised position, according to an embodiment of the invention. The lifting frame 160, along with the attached lift platform 190, can be raised or lowered by actuation of the winch 100. In a preferred embodiment, this is accomplished by turning the winch handle 102 of the manual winch 100. In use, the lift platform 190 is configured and latched in the horizontal position, and then lowered to the ground by actuation of the winch 100, where the load, such as a hay bale, game animal carcass, camping supplies, or stretcher can be loaded. As desired, the load may be secured by use of tiedowns 196, if available. The lift platform 190 is then raised clear of the ground by actuation of the winch 100, and can be transported by the motorized vehicle to its destination.

FIG. 4 is a perspective view showing the right side of the lift apparatus with the lift platform 190 in a raised position, illustrating the pivoting of the lift platform 190 into a stowed position, according to an embodiment of the invention. Alternative attachment means, such as mounting brackets 122, may be used to attach the mounting frame 110 to the tailgate of a all-terrain utility vehicle having a cargo bed. To stow the lift platform 190, the user removes the removable pins 184 from the lift platform support arms 180 that are latching the lift platform 190 to the lift platform attachment member 166. The lift platform 190 remains supported in the horizontal position by the lift platform attachment member 166, and the lift platform 190 may then be pivoted into a vertical configuration parallel to the lifting frame 160. In a preferred embodiment, one of the removable pins 184 may be used to latch the lift platform 190 in a vertical position by inserting it into a hold down pin hole 168 in the lifting frame, as shown in FIG. 5.

FIG. 5 is a perspective view showing the front of the lift apparatus with the lift platform 190 in a raised and stowed position, and illustrating a removable pin 184 in position for latching the lift platform in a stowed position, according to an embodiment of the invention. A winch 100 is attached to the mounting frame, and in a preferred embodiment, the winch is a manual winch attached to the top of the mounting frame 110 with bolts 104, that are secured by nuts 106. A cable 170 attached to the winch 100 feeds through an upper cable passthrough 112 hole centered in the top of the mounting frame 110 and through a similar lower cable passthrough 162 hole centered in the top of a lifting frame 160, where it is attached to a cable connection point 164 on the lifting frame 160 by a cable connector 172, such as a hook or carabiner. In a preferred embodiment, the cable 170 is a steel cable, the cable connection point 164 is an eye bolt, and the cable connector 172 is a safety hook. The upper 124 and lower 134 cable passthrough holes may be provided with grommets, if desired, as is well known in the art. In a preferred embodiment, one of the removable pins 184 may be used to latch the lift platform 190 in a vertical position by inserting it into a hold down pin hole 168 in the lifting frame 160. In the stowed configuration, the removable pin 184 extends across the rail 192 of the lift platform 190 blocking the lift platform 190 from pivoting down into the horizontal position. Alternative latching mechanisms may be used, and will be obvious to those skilled in the art.

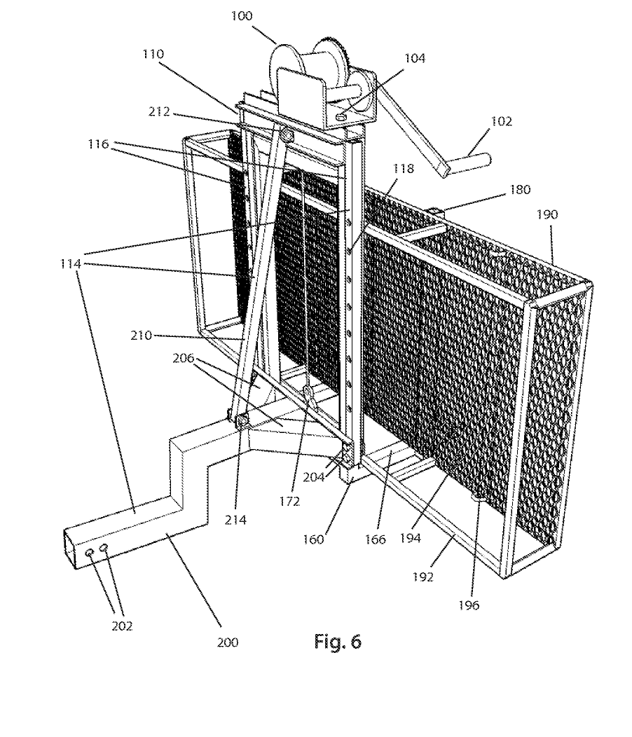

FIG. 6 is a perspective view showing the back of the lift apparatus with the lift platform in a raised and stowed position, and illustrating an adjustable receiver mount 200, according to an embodiment of the invention. The adjustable receiver mount 200 may be configured to slide into the receiver hitch of an all-terrain vehicle, and secured to the receiver hitch by a pin passing through the receiver hitch and one of the receiver adjustment holes 202 of the adjustable receiver mount 200. Horizontal braces 206 may be attached to the adjustable receiver mount 200 to provide horizontal support and stability. In a preferred embodiment, these horizontal braces 206 are attached to the adjustable receiver mount 200 by welding. A vertical brace 210 may be attached to the adjustable receiver mount 200 to provide vertical support and stability. In a preferred embodiment, the vertical brace is attached to the adjustable receiver mount 200 with a bolt 214. The vertical brace 210 may be attached to the upper portion of the mounting frame 110 of the lift apparatus by a bolt 212, and the horizontal braces may be attached to the lower portion of the mounting frame 110 by bolts 204. In a preferred embodiment, the adjustable receiver mount 200, the horizontal braces 206 and the vertical brace 210 are made from square steel tubing, and assembled by welding, except where mechanical fasteners are used as described earlier.

Although the invention has been shown and described with reference to certain specific presently preferred embodiments, the given embodiments should not be construed as limitations on the scope of the invention, but as illustrative examples, and those skilled in the art to which this invention pertains will undoubtedly find alternative embodiments obvious after reading this disclosure. With this in mind, the following claims are intended to define the scope of protection to be afforded the inventor, and these claims shall be deemed to include equivalent constructions insofar as they do not depart from the spirit and scope of the present invention.

I claim:

1. A cargo lift for an all-terrain vehicle, comprising:
a mounting frame comprising an upper portion and a lower portion, said upper portion of said mounting frame comprising a passthrough opening;
an adjustable attachment means for attaching said mounting frame to an all-terrain vehicle;
a winch attached to said mounting frame;
a lifting frame slidably positioned within said mounting frame, said lifting frame comprising a passthrough opening, an attachment point, and a lift platform attachment member;
at least one lift platform support arm pivotably mounted to said lift platform attachment member, said at least one lift platform support arm configured to pivot between a horizontal position and a vertical position;
a lift platform for supporting a load, said lift platform attached to said at least one lift platform support arm and configured to pivot therewith between a horizontal position and a vertical position; and
a flexible member having a first end and second end, said first end attached to and driven by said winch, and said second end attached to said attachment point of said lifting frame, said flexible member passing through said passthrough opening in said mounting frame and said passthrough opening in said lifting frame.

2. The cargo lift as in claim 1, wherein the adjustable attachment means comprises at least one adjusting bar, said at least one adjusting bar comprising a plurality of holes; and at least one mounting bracket configured to repositionably attach to said at least one adjusting bar by means of one or more of said plurality of holes.

3. The cargo lift as in claim 1, wherein said adjustable attachment means comprises an adjustable receiver mount configured to slide into the receiver hitch of an all-terrain vehicle, said adjustable receiver mount comprising at least one hole configured to accept a pin removably inserted into a hole in the receiver hitch of an all-terrain vehicle; a vertical brace having a first end and a second end, said first end of said vertical brace attached to said adjustable receiver mount and said second end of said vertical brace attached to said upper portion of said mounting frame; and a pair of horizontal braces each having first end and a second end, said first ends of said horizontal braces attached to said adjustable receiver mount and said second ends of said horizontal braces attached to said lower portion of said mounting frame.

4. The cargo lift as in claim 2, wherein the at least one mounting bracket is a U-bolt.

5. The cargo lift as in claim 2, wherein the at least one mounting bracket is an L-bracket.

6. The cargo lift as in claim 1, wherein the winch is a manual winch.

7. The cargo lift as in claim 1, wherein the winch is a powered winch.

8. The cargo lift as in claim 1, further comprising a means for reversibly fixing said at least one lift platform support arm in a horizontal position.

9. The cargo lift as in claim 8, wherein said means for reversibly fixing said at least one lift platform support arm in a horizontal position comprises a mounting hole proximate to the pivot axis of said at least one lift platform support arm; a mounting hole in said lift platform attachment member corresponding to said mounting hole in said at least one lift platform support arm, said mounting hole in said at least one lift platform support arm configured to be aligned with said mounting hole in said lift platform attachment member when said at least one lift platform support arm is in a horizontal position; and a removable pin configured to be inserted through said mounting hole in said at least one lift platform support arm and said mounting hole in said lift platform attachment member when said at least one lift platform support arm is in a horizontal position.

10. The cargo lift as in claim 8, further comprising a means for reversibly fixing said lift platform in a vertical position.

11. The cargo lift as in claim 9, further comprising a means for reversibly fixing said lift platform in a vertical position.

12. The cargo lift as in claim 11, wherein said lift platform further comprises a rail configured to prevent a load from sliding off the lift platform.

13. The cargo lift as in claim 12, wherein said means for reversibly fixing said lift platform in a vertical position comprises at least one hold down pin hole in said lifting frame, said at least one hold down pin hole in said lifting frame configured to accept a removable pin, and said at least one hold down pin hole in said lifting frame located proximate to the position of said rail when said lift platform is in a vertical position, and said removable pin configured to latch said rail against said lift platform attachment member when inserted in said hold down pin hole when said lift platform is in a vertical position.

14. A cargo lift for an all-terrain vehicle, comprising:
a mounting frame comprising an upper portion and a lower portion, said upper portion of said mounting frame comprising a passthrough opening;
a manual winch attached to said mounting frame;
a lifting frame slidably positioned within said mounting frame, said lifting frame comprising a passthrough opening, an attachment point, and a lift platform attachment member;
at least one lift platform support arm pivotably mounted to said lift platform attachment member, said at least one lift platform support arm configured to pivot between a horizontal position and a vertical position;
a means for reversibly fixing said at least one lift platform support arm in a horizontal position;
a lift platform for supporting a load, said lift platform attached to said at least one lift platform support arm and configured to pivot therewith between a horizontal position and a vertical position;
a means for preventing a load from sliding off said lift platform;
a means for reversibly fixing said lift platform in a vertical position; and
a flexible member having a first end and second end, said first end attached to and driven by said winch, and said second end attached to said attachment point of said lifting frame, said flexible member passing through said passthough opening in said mounting frame and said passthrough opening in said lifting frame.

15. The cargo lift as in claim 14, wherein the adjustable attachment means comprises at least one adjusting bar, said at least one adjusting bar comprising a plurality of holes; and at least one mounting bracket configured to repositionably attach to said at least one adjusting bar by means of one or more of said plurality of holes.

16. The cargo lift as in claim 15, wherein said means for preventing a load from sliding off said lift platform comprises a rail.

17. The cargo lift as in claim 16, wherein said means for reversibly fixing said at least one lift platform support arm in a horizontal position comprises a mounting hole proximate to the pivot axis of said at least one lift platform support arm; a mounting hole in said lift platform attachment member corresponding to said mounting hole in said at least one lift platform support arm, said mounting hole in said at least one lift platform support arm configured to be aligned with said mounting hole in said lift platform attachment member when said at least one lift platform support arm is in a horizontal position; and a removable pin configured to be inserted through said mounting hole in said at least one lift platform support arm and said mounting hole in said lift platform attachment member when said at least one lift platform support arm is in a horizontal position.

18. The cargo lift as in claim 16, wherein said means for reversibly fixing said lift platform in a vertical position comprises at least one hold down pin hole in said lifting frame, said at least one hold down pin hole in said lifting frame configured to accept a removable pin, and said at least one hold down pin hole in said lifting frame located proximate to the position of said rail when said lift platform is in a vertical position, and said removable pin configured to latch said rail against said lift platform attachment member when inserted in said hold down pin hole when said lift platform is in a vertical position.

19. The cargo lift as in claim 14, wherein said adjustable attachment means comprises an adjustable receiver mount configured to slide into the receiver hitch of an all-terrain vehicle, said adjustable receiver mount comprising at least one hole configured to accept a pin removably inserted into a hole in the receiver hitch of an all-terrain vehicle; a vertical brace having a first end and a second end, said first end of said vertical brace attached to said adjustable receiver mount and said second end of said vertical brace attached to said upper portion of said mounting frame; and a pair of horizontal braces each having first end and a second end, said first ends of said horizontal braces attached to said adjustable receiver mount and said second ends of said horizontal braces attached to said lower portion of said mounting frame.

20. The cargo lift as in claim 18, wherein said adjustable attachment means comprises an adjustable receiver mount configured to slide into the receiver hitch of an all-terrain vehicle, said adjustable receiver mount comprising at least one hole configured to accept a pin removably inserted into a hole in the receiver hitch of an all-terrain vehicle; a vertical brace having a first end and a second end, said first end of said vertical brace attached to said adjustable receiver mount and said second end of said vertical brace attached to said upper portion of said mounting frame; and a pair of horizontal braces each having first end and a second end, said first ends of said horizontal braces attached to said adjustable receiver mount and said second ends of said horizontal braces attached to said lower portion of said mounting frame.
